(19) United States
(12) Patent Application Publication
(10) Pub. No.: US 2025/0004889 A1
(43) Pub. Date: Jan. 2, 2025

(54) SYSTEM AND METHOD FOR BREAK RESOLUTION AUTOMATION

(71) Applicant: THE BANK OF NEW YORK MELLON, New York, NY (US)

(72) Inventors: Shriniwas IYENGAR, New York, NY (US); Gerald VERRILLI, Florham Park, NJ (US); Narayan JHA, New York, NY (US)

(21) Appl. No.: 18/344,541

(22) Filed: Jun. 29, 2023

(51) Int. Cl. G06F 11/14

(52) U.S. Cl. CPC G06F 11/1474; G06Q 40/00

(57) ABSTRACT

Provided are processes, systems, and methods for automation of investigation and resolution of transaction breaks such as, for example, a trade break, a reconciliation break, a dividend break, or a security position break. Breaks (e.g., discrepancies in records of transactions) often occur when there exist different systems or applications that operate in concert. A break refers to a situation where there is a discrepancy between details, attributes, or characteristics of a transaction across different computing systems or applications. In many cases, there exists a need to ensure consistency between the records of these different systems. Thus, for example, an entity may desire to resolve those breaks, such as to reduce risk, maintain compliance, or to provide accurate accounting of records.

### CROSS-REFERENCE TO RELATED APPLICATIONS

No cross-reference is presented at this time.

### BACKGROUND

With the advent of computers, computer systems or applications that automate numerous transactions of assets have proliferated. In many cases, multiple such computer systems or applications may be authorized to perform transactions for assets within an account, or one or more computer systems or applications automating transactions of assets may report transactions to other computer systems or applications that act upon those transactions. For example, a customer may utilize an accounting or trading application to specify trades of assets that are held, or to be held, in custody by another party, like a bank, which may utilize a custody application to manage those assets. Inflows and outflows of quantities and values of assets between the accounting application and the custody application should match, but this is often not the case in practice, and these discrepancies are referred to as breaks.

### SUMMARY

Aspects of the disclosure relate to methods, apparatuses, and/or systems for identifying, evaluating, and repairing a break.

In some aspects, an indication of a break that has occurred in a transaction system is received and a set of transactions associated with the break is identified. Information corresponding to the break, which may include information about transactions in the set of transactions, is obtained. For example, aspects may obtain internal data pertaining to the break and/or obtain external data pertaining to the break, e.g., from one or more external data sources such as third-party systems, external entities or databases, related entities, unaffiliated sources, auxiliary or alternative data sources, etc. The break is classified based on the set of transactions, the internal data, and the external data. A type of repair to perform may be determined based at least in part on the classification of the break and a break resolution may be initiated based on the determined type of repair.

Various other aspects, features, and advantages will be apparent through the detailed description and the drawings attached hereto. It is also to be understood that both the foregoing general description and the following detailed description are exemplary and not restrictive of the scope of the disclosure.

### BRIEF DISCUSSION OF THE DRAWINGS

FIG. 1 illustrates a block diagram of an environment for asset management within which the present techniques may be implemented, in accordance with some embodiments;

FIG. 2 illustrates a block diagram of a reconciliation system, in accordance with some embodiments;

FIG. 3 illustrates a logic flowchart for processing a break, in accordance with some embodiments; and

FIG. 4 illustrates a block diagram depicting an example of a computing device by which the above techniques may be implemented.

While the present techniques are susceptible to various modifications and alternative forms, specific embodiments thereof are shown by way of example in the drawings and will herein be described in detail. The drawings may not be to scale. It should be understood, however, that the drawings and detailed description thereto are not intended to limit the present techniques to the particular form disclosed, but to the contrary, the intention is to cover all modifications, equivalents, and alternatives falling within the spirit and scope of the present techniques as defined by the appended claims.

### DETAILED DESCRIPTION

To mitigate the problems described herein, the inventor had to both invent solutions and, in some cases just as importantly, recognize problems overlooked (or not yet foreseen) by others in the field of identifying, evaluating, and repairing a break. Indeed, the inventor wishes to emphasize the difficulty of recognizing those problems that are nascent and will become much more apparent in the future should trends in industry continue as the inventors expect. Further, because multiple problems are addressed, it should be understood that some embodiments are problem-specific, and not all embodiments address every problem with traditional systems described herein or provide every benefit described herein. That said, improvements that solve various permutations of these problems are described below.

Breaks (e.g., discrepancies in records of transactions) often occur when there exists different systems or applications that operate in concert. A break refers to a situation where there is a discrepancy between details, attributes, and/or characteristics of transactions across different computing systems or applications. In many cases, there exists a need to ensure consistency between the records of these different systems. Thus, for example, an entity often desires to resolve those breaks, such as to reduce risk, maintain compliance, or accurate accounting of records. Some examples of breaks may include, but are not limited to, trade breaks, reconciliation breaks, dividend breaks, or security position breaks trade settlement breaks, corporate action breaks, withholding tax breaks, securities lending breaks, short-term investment fund interest breaks, custody fee breaks, loan principal prepayment breaks, loan interest prepayment breaks, or management fee breaks, among others.

In some examples, certain entities (e.g., banks) may perform financial reconciliations across various systems (e.g., risk and control) to maintain compliance, such as with respect to regulations, audits, or reviews. For many such entities, maintaining compliance involves implementing ongoing and proactive processes that are enforced internally (or externally, or both). Here, a break may correspond to a discrepancy between transactions of assets reported by different applications. For example, an accounting application may show a position for a security of 100 but a custody application may show a position for the same security of 50. The difference of 50 represents a break that needs to be investigated. Similarly, transaction breaks may occur for reported cash transactions, where there exists a discrepancy between transactions records associated with different accounts or entities.

In other examples, a shipper, merchant, or manufacturer may utilize different computing systems or applications, like a customer facing application and an internal application, and the inflows and outflow of products, orders, or materials should match (or be maintained within threshold levels). Here, a break may similarly correspond to a discrepancy between transactions of assets reported by different applications. For example, a customer facing application may show that 100 widgets were purchased and shipped to the customer while an internal application may show that only 50 widgets were shipped. Accordingly, the difference of 50 represents a break that needs to be investigated.

Breaks can happen for a variety of reasons including, for example, transaction timing, messaging failures between systems, human errors, and the like. When a break occurs, an operations team typically investigates the root cause and generates correcting transactions (e.g., write offs) to clear breaks. Generally, this process is performed manually and in a piece-meal fashion, which is time and labor-intensive. In addition, there is a large variety of the types of breaks which might occur, each requiring a specific solution. Additionally, breaks are often prioritized incorrectly, which can cause operations teams to address some less critical breaks before addressing others that are more critical. These difficulties often compound potential concerns for entities that use systems prone to breaks, as those traditional processes for resolving breaks require substantial operations teams labor input that may, in some cases, be allocated inefficiently. Embodiments described herein mitigate these issues with a reconciliation system that facilitates classification, validation, and resolution of breaks in an automated fashion.

Those with skill in the art will appreciate that inventive concepts described herein may work with various system configurations. In addition, various embodiments of this disclosure may be made in hardware, firmware, software, or any suitable combination thereof. Aspects of this disclosure may also be implemented as instructions stored on a machine-readable medium, which may be read and executed by one or more processors. A machine-readable medium may include any mechanism for storing or transmitting information in a form readable by a machine (e.g., a computing device, or a signal transmission medium), and may include a machine-readable transmission medium or a machine-readable storage medium. For example, a machine-readable storage medium may include read only memory, random access memory, magnetic disk storage media, optical storage media, flash memory devices, and others. Further, firmware, software, routines, or instructions may be described herein in terms of specific exemplary embodiments that may perform certain actions. However, it will be apparent that such descriptions are merely for convenience and that such actions in fact result from computing devices, processors, controllers, or other devices executing the firmware, software, routines, or instructions.

In some example transactions, a customer or user buys or sells assets (e.g., securities) that are to be held or held by an entity, like a bank or other financial institution. The customer may utilize a customer facing accounting application to submit or otherwise view those transactions, which in some examples may be part of or otherwise linked to a trading platform. The account application may communicate via messages with an application of the bank or financial institution that has custody of the held securities or cash with which securities are purchased to be held by the bank or transferred to the bank, e.g., as collateral, etc. For example, the account application may communicate transactions to be effectuated to the custody application via one or more messages, and those transactions may be effectuated for the customer. Thus, the accounting application and custody application may each maintain respective records of transactions which, when reviewed, are expected to agree. As noted above, discrepancies in the respective records of transactions can occur, and these discrepancies should be resolved. Accordingly, accounting application records and custody application records may be obtained from the respective applications, or computing systems executing the respective applications.

In some embodiments, a reconciliation automation system (RAS) is utilized to execute all or some of processes, such as, for example, processes to resolve breaks that are identified based on comparisons between accounting application records and custody application records. Processes associated with the RAS may execute on one or more computing systems, which in some examples may include distributed computing systems. In some examples, the RAS may orchestrate the execution of one or more processes by one or more external systems, such as in response to determinations made by components of the RAS, or output messages based on those determinations upon which other applications or systems may act, whether by executing a process or updating records based on message data.

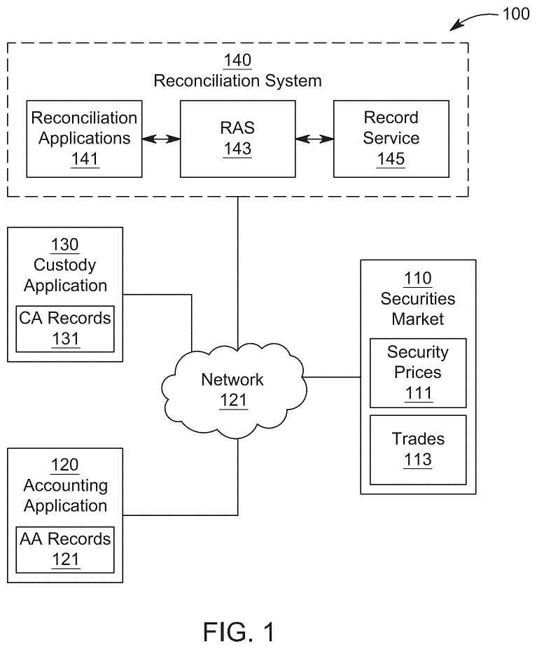

FIG. 1 illustrates a functional block diagram of an embodiment of an environment for asset management 100 within which at least some of the present techniques may be implemented. Within the environment 100, entities may engage in the trading (e.g., buying or selling, and other activities) of assets (examples of which may include securities), e.g., made available on a market 110, like a securities market (or exchange), via network 121. For example, one or more entities may specify transactions or information for transactions by which securities available on the market 110 are traded. In some embodiments, assets (e.g., securities) may also be traded off-market, e.g., via OTC instruments. Accordingly, RAS 143 may support break-processing for Alternative Investment Services (AIS) reconciliations, which may involve hedge funds, private equity funds, etc. Applications and systems or components of systems, such as example applications 120, 130 and system 140 (which may include multiple components, like various applications, databases, etc., as shown) may communicate with one or more of the other applications or system components, securities market 110 or other entities via the network 121, which is not to suggest that each entity must communicate with each other entity within the environment 100.

In some examples, an application (e.g., like applications 120, 130, 141) may be executed on a respective computing system, though this need not always be the case. In some examples, one or more of the applications may be executed on a single computing system (which is not to suggest that such a computing system may not include multiple computing devices or nodes, or that each computing device or node need be co-located, indeed, a computing system comprising multiple servers that house multiple computing devices may be operated by a single entity and the multiple servers may be distributed geographically). For example, in some embodiments, an entity may execute both a custody application 130 and implement a reconciliation system 140, or aspects thereof, on a computing system of the entity. Moreover, in some examples, the entity may also provide customers access to an accounting application 120, which may be a web-based application hosted by a computing system managed by or provisioned by the entity, or which communicates with such a computing system via an application programming interface (API). Additionally, computing systems of securities markets 110 may provide interfaces by which other applications or systems, like one or more of those depicted or other external systems, may communicate with a securities market, such as to obtain security prices or effectuate trades of securities available on the market. Accordingly, one or more of the depicted entities (and in some examples, one or more of their components) may communicate with one another via messages transmitted over a network 121, such as the Internet and various other local area networks.

In some example embodiments, a securities market 110 is a public market for buying and selling securities, such as via trades 113 of a security. The securities market 110 may be a platform which tracks trading of securities listed on the platform and market prices of those securities. Security prices 111 may be made public by the securities market 110 to facilitate trading in those securities, such as the buying or selling of a security based on the market price of that security. Applications or systems, like an accounting application 120, custody application 130, or reconciliation system 140 may access security prices 111 in different ways. In some cases, prices 111 may be obtained by one or more of the applications from the securities market 110, such as from a computing system of the securities market via the network 121. In some cases, prices 111 may be obtained by one or more of the applications from an external data source, e.g., a third party server or other computing system that may aggregate security prices obtained from a number of different securities markets and provide those prices, such as via an API, to other applications or computing systems. In either case, computing systems executing applications like those depicted within the environment 100 may obtain market security pricing information, often in real or near real-time, corresponding to securities traded on the securities market 110.

In some example embodiments, an accounting application 120 is a user-facing application with which a user, such as for example, a customer or client, interfaces to manage their assets. While only one instance of an accounting application 120 is shown, embodiments of the environment 100 may include tens, hundreds, or thousands or more such applications accessed by different users on or from their respective computing systems. In some examples, such an application may also, or alternatively, be used internally, such as by an account or fund manager that specifies transactions for a customer or within a fund. The accounting application 120 and users of the accounting application may be isolated from accessing some or all of the information associated with the custody application 130 or reconciliation system 140. For example, an accounting application 120 may be a multi-tenant application to which multiple different users have access and which only displays tenant-specific data to the respective tenant (e.g., customer or user). An interface, like an API associated with a custody application 130 or reconciliation system 140, may facilitate the exchange of tenant-specific data (e.g., only the data which a user/user account of the accounting application 120 is permitted to view) between an account application 120 and other applications or systems that manage that data and data for other tenants, like via messages transmitted over network 121. For example, a user of an account application 120 may access their customer account information or information about transactions and their properties specified by the user on the accounting application, and information about success/failure of processing a transaction, but not information about how other applications or systems processed that transaction (e.g., via one or more trades 113 on the securities market 110, by assets held by the bank to minimize trade fees on the securities market, or combination thereof consistent with the properties that were specified by the user), among other information associated with the bank or other users (e.g., tenants) and their accounts.

In some example embodiments, an accounting application 120 may access information about securities, such as security prices 111, from the securities market 110 (or from an external data source), to determine whether to effectuate one or more trades 113 of a security on the market 110, which in some examples may involve transmitting properties for a transaction to be effectuated on the market. In other example uses cases, the accounting application 120 may access information about shipping rates, quantities of assets (e.g., goods) available (e.g., in inventory), costs of assets (e.g., market), among other information by which a transaction for goods or services may be specified. The accounting application 120 may store or otherwise generate associated accounting application (AA) records 121 indicative of properties of transactions specified by users of the accounting application to be effectuated. An example of such transactions and their associated properties may be for trades (e.g., buying, selling, etc.) 113 of securities on a securities market 110 based on security prices 111. It should be noted that various embodiments may access other information in addition to and/or in place of securities prices, for example FX rates, interest rates, etc.

In some example embodiments, a custody application 130 is an internally facing application by which agents or employees of an entity manage assets of the entity. While only one instance of a custody application 130 is shown, embodiments of the environment 100 may permit multiple agents or employees of an entity implementing the custody application 130 to access respective instances of such an application from their respective computing systems. In some examples, a custody application 130 may provide information about assets held by the entity, and transactions corresponding to those assets. Some or all of those transactions may be effectuated by the entity based on properties of transactions specified by users of accounting applications 120.

In some example embodiments, the custody application 130 may access information about securities, such as security prices 111, from the securities market 110 (or from an external data source), to determine how to effectuate one or more trades 113 of a security available on the market 110 (or in some cases, already held and made available by the bank). Thus, in some examples, the custody application 130 may determine properties for one or more transactions to buy or sell (e.g., trade) securities (e.g., in accordance with policies or rules of the bank). Those properties determined by the custody application 130 may be based on properties for a transaction specified by users of accounting applications 130, such as with respect to assets associated with a respective customer account with the entity. In practice, the custody application 130 may determine properties for one or more transactions that satisfy properties specified for a transaction (or even multiple transactions) by custody applications 130. In other words, the custody application 130 may determine how to satisfy properties of transactions requested by users of custody applications 120 based on market 110 security prices 111, assets held by the bank (and returns on selling those assets based on the security prices 111), and other factors, and generate one or more transactions based on rules or policies of the bank determined to satisfy those transactions requested by users. The custody application 130 may obtain properties of transactions, such as for trades 113 of securities, requested by users from the accounting application 120, or a customer with access to the accounting application 120 (in which case the properties may be entered on the respective applications manually, e.g., by the customer on the accounting application 120 and by an agent of the bank on the custody application 130). In turn, the custody application 130 may store custody application (CA) records 121 indicative of transactions performed by the custody application to satisfy properties of transactions requested by accounting applications 120.

An application, like the custody application 130, may obtain requests for transactions corresponding to trades on the securities market 110 and generate transactions for processing. For example, the custody application 130 may generate transactions based on requests for transactions received from an accounting application 120, which may store information about those requests in AA Records 121. The AA Records 121 may be indicative of a requested transaction, like an identifier of a security, whether to buy or sell the security, a price at which to buy or sell, and a quantity of the security. The custody application 130 may submit a transaction for a trade 113 for processing on the securities market 110, such as to buy or sell stock or other security traded on the market. The securities market 110 may match one or more transactions to buy a security with one or more transactions to sell a security, e.g., trades, and return confirmation of a trade corresponding to a transaction received from the custody application 130. The trade may then be settled, such as by the exchange of assets between a buyer and a seller, with an account managed by the custody application 130 being debited the trade cost in exchange for obtaining a corresponding amount of the security in the case of a buy or credited the trade cost in exchange for releasing a corresponding amount of the security in the case of a sell. The custody application 130, in turn, may store CA Records 131 indicative of the transaction, like an identifier of a security, whether it was a buy or sell, a trade price and market price of the security, and a quantity of the security exchanged. Additionally, a trade cost may be determined which, generally, may be the trade price times the quantity, although in some examples a trade cost may be adjusted to incorporate associated trade fees (which may be omitted for purposes of discussion herein without departing from the inventive aspects of the disclosed techniques).

In some example embodiments, a reconciliation system 140 may obtain records from at least two different sources to identify breaks in transactions described by those records and attempt to resolve identified breaks. For example, the reconciliation system 140 may obtain CA Records 131 from a custody application 130 and AA Records 121 from an accounting application. In some examples, the custody 130 and accounting 120 applications may generate reports comprising the respective records, such as for a given time period, like one or more minutes, hours, days, weeks, or months, which are then obtained by the reconciliation system 140. In some examples, the reconciliation system 140 may request records from one or more of custody application 130 and accounting application 120 corresponding to a given time period. In either case, the reconciliation system 140 may obtain a set of AA Records 121 and set of CA records, e.g., a first set of records and a second set of records for comparison, such as for a given time period, for identifying breaks.

As shown, the reconciliation system 140 may include (or support) multiple components, such as one or more reconciliation applications 141, a reconciliation automation system (RAS) 143, and record service 145. In some examples, one or more reconciliation applications 141 may obtain record sets for analysis, such as to identify a break corresponding to one or more transactions described in the records. For example, a reconciliation application 140 may compare a first set of records, like AA Records 121, to a second set of records, like CA Records 121, which are expected to agree. However, as noted above, discrepancies in the respective records of transactions can occur. Embodiments of a reconciliation application 140 may identify one or more discrepancies, like an exception quantity, between the first and second set of records based on transactions indicated in the records. In some embodiments, the reconciliation application 141 identifies an exception corresponding to a break based on the analysis of a first and second set of records. The reconciliation application 140 may, in turn, generate a message indicative of the exception, like a break record, including information about the break and transactions associated with the break.

The reconciliation application 140 may output the message, such as on a message bus (not shown), by which example components of the reconciliation system 140 (among others) may communicate information. Example embodiments of a message bus may support one or more messaging services by which entities communicate information within the reconciliation system 140 or environment 100, such as RabbitMQ or Kafka. One or more other entities may obtain and response to messages on the message bus. For example, a message on the bus may be transmitted (e.g., routed) to an indicated recipient entity. In other examples, an entity may subscribe to the messaging bus to obtain all or a subset of messages, like a feed. In some examples, an obtained message may trigger one or more processes and/or responses (such as based on results of the processes) by the receiving entity, like an API response. Example APIs described herein may be RESTful APIs, which may be implemented by a lightweight RESTful API service wrapper by which functions of an application or system may be called by other entities, such as to retrieve data or process data based on the request.

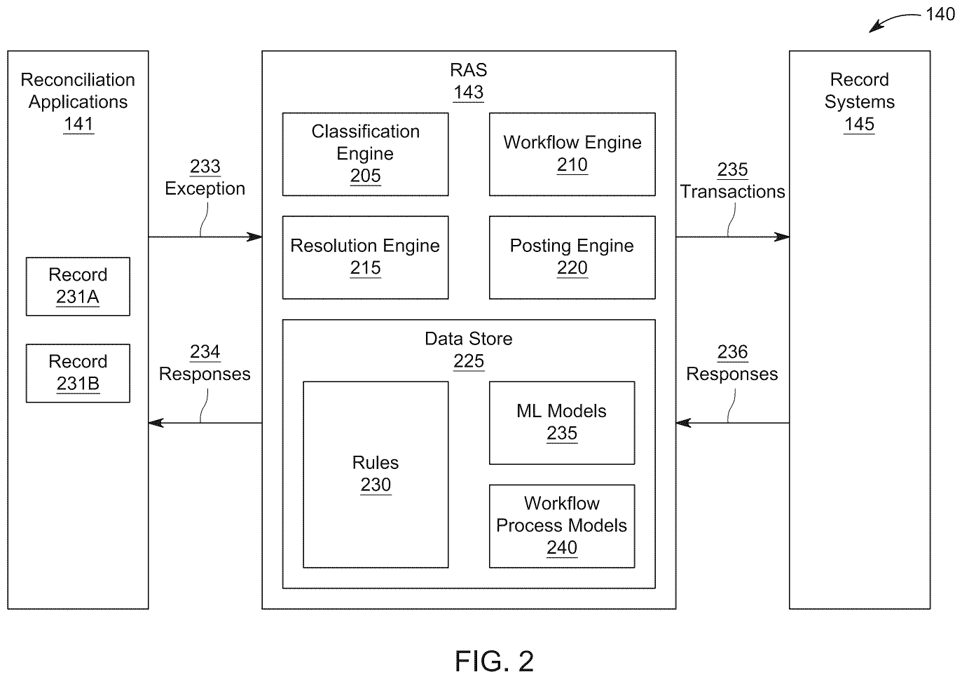

Embodiments of the RAS 143 may obtain requests to process a break, such as via a message on a messaging service. In response to obtaining a request to process a break, the RAS 143 may orchestrate processing and resolution of the break. For example, RAS 143 may classify a break, process the break based on the classification to determine a resolution corresponding to the break, and post results to effectuate the resolution. In some examples, the RAS 143 may interface with one or more external data sources (e.g., third-party services/servers or other alternative/ancillary data sources), such as to obtain security prices 111, or to specify transactions which may correspond to one or more trades 113 to resolve a break. The RAS 143 may output information about the processing of a break on a message bus, such as to update one or more other entities as to the status of processing the break or results of processing the break. For example, in response to obtaining an exception message, the RAS 143 may assign an identifier, like a RAS ID, to a break and output the RAS ID on the message bus for updating of a reconciliation application 141 record of the break. In turn, results of break processing output by the RAS 143 may be associated with the RAS ID. For example, the RAS 143 may output (e.g., post) one or more corrective transactions or other results in association with a RAS ID corresponding to the break by which reconciliation applications 141 may identify those results as being associated with the break record, such as in response to obtaining updated record sets including transaction information based on the results. In some examples, output messages about a corrective transaction may include information identifying a record source to which that transaction corresponds. Example embodiments of the RAS 143 are discussed in greater detail with reference to FIG. 2.

In some embodiments, a record service 145 may obtain outputs of the RAS 143 corresponding to break processing. For example, the record service 145 may obtain messages about corrective transactions output by the RAS 143. The record service 145, in some embodiments, may convey information about corrective transactions to a corresponding record source, such as based on a record source identifier indicated by the RAS 143. For example, if a message indicates information about a corrective transaction to be posted to accounting application 120, the record service 145 may route the message or information from the message to the accounting application. Conversely, if a record source identifier associated with a message corresponds to a custody application 130, the record service 145 may route the message or information from the message to the custody application 130. In other examples, one or more such applications may request updates from the record service 145, such as periodically, to obtain information about any corrective transactions corresponding to the application. Additionally, the record service 145 may, in some examples, store and convey (e.g., post) corrective transactions to applicable systems for effectuating (manually, automatically or via a combination of both, e.g., semi-automatically) a trade of a security, cash write off, or other determination output by the RAS 143 for resolution of a break. In some examples, various thresholds (e.g., like a threshold value) may be applied to determine whether results output by the RAS 143 are acted upon automatically or require manual approval to resolve a break. The record service 145 may store information about breaks, processing thereof, and results output by the RAS 143, such as for analytics or auditing of RAS operation.

FIG. 2 illustrates a block diagram of an example reconciliation automation system 140, examples of which may implement a reconciliation automation system 143 to facilitate the processing of breaks. As shown in FIG. 2, one or more reconciliation applications 141 and record system 145 may communicate with RAS 143, such as via messages or API requests and vice versa. Although not show for ease of explanation, embodiments should not be construed as limiting to only those communication paths shown. Indeed, embodiments may implement a messaging bus (not shown) by which various ones of the applications, components, or systems depicted in FIG. 2 (or FIG. 1) may communicate to exchange data. Moreover, various ones of the applications, components, or systems may communicate via APIs, such as by requests and responses, to facilitate the exchange of data. Additionally, one or more of the illustrated applications, components, or systems may communicate with other external data systems as described herein.

The reconciliation system 140 may obtain records such as record 231A and record 231B, which may correspond to transactions reported by different entities. For example, a custody application may report transaction record 231A and an account application may report transaction record 231B. In some examples, the records may be obtained by a reconciliation application 141 for comparison, such as to determine whether there is a break in transactions reported in the records 231. Example reconciliation applications 141 may include, but are not limited to, internal reconciliation tools and/or external enterprise reconciliation utilities.

The reconciliation application 141 may, in response to obtaining records 231A, 231B from different sources, compare the records to determine whether transaction data of the records is indicative of an exception, such as a break between transactions described by records 231A and transactions described by records 231B. The reconciliation application 141 may transmit information about a detected exception to the RAS 143 for processing (e.g., a request to process a break). For example, the reconciliation application 141 may transmit an exception 233 message, such as via a messaging service or request, which may be received by an API of the RAS 143.

An initial response 234 by the RAS 143, may be an acknowledgment of receipt of the request or receipt of the information about the detected exception. Embodiments of the RAS 143 may generate, for each detected exception, a reconciliation automation system identifier (RAS ID) that is uniquely assigned to that break. The RAS ID assigned to a break in response to receipt of an exception message 233 may be returned to the reconciliation application 141 in association with the initial response 234 by the RAS 143. Thus, for example, the reconciliation application 141 may receive and associate the RAS ID with information about the exception 233 it generated. For example, the reconciliation application 141 may identify a set of transactions corresponding to a break and generate an exception message 233 indicative of the detection of a break. Information about the break conveyed by the exception message 233, which may include the set of transactions and, optionally, other information about those transactions already obtained (or determined) by the reconciliation application 141, may be stored and flagged by the reconciliation application 141 as an unresolved break. Examples of such information may include transaction information for each transaction in the set as reported in the records, which record source a transaction pertains to (like a given one of the record systems), and the like. Thus, for example, the reconciliation application 141 may associate a RAS ID returned in response 234 to an exception message 233 with information about the unresolved break.

After determining a resolution to a break, the RAS 143 may output one or more repair transactions 235 (e.g., that were determined to resolve the break) having transaction information indicating the RAS ID of the associated break to one or more record systems 145. When a repair transaction is effectuated by a corresponding record system 145 it is included in updated records of transactions by the record system 145. In turn, the reconciliation application 141 may identify those repair (e.g., corrective) transactions within next or updated record sets based on RAS IDs included in their transaction information as being associated with an identified exception/break that was previously sent to the RAS 143 for processing (e.g., such that they are analyzed with respect to the set of transactions of the corresponding break and not other transactions in the new records).

In some examples, during a next matching phase (e.g., the next hour, next day, next month, quarter, etc.) involving the processing of updated records from the sources that generated records 231A, 231B, the reconciliation application 141 may examine transaction information associated with the new transactions described therein for the presence of RAS IDs. For example, the reconciliation application 141 may determine whether a RAS ID contained in transaction information associated with a new transaction reported in the records matches the RAS ID of an unresolved break. In other words, the reconciliation application 141 may identify any newly reported transaction described in the records as corresponding to a previously identified break that is unresolved based on a matching of the RAS IDs. The reconciliation application 141 may obtain the set of transactions corresponding to the break, such as based on associated RAS ID, and determine whether repair transactions correct the break (e.g., that no exception is detected when the transactions associated with the break are examined in connection with the one or more repair transactions). In some examples, a repair transaction may be a new transaction that is examined in combination with the set of transactions corresponding to the break. For example, a repair transaction may adjust a quantity of an asset or decrease or increase a balance with respect to one of the records 231A, 231B to enforce consistency in response to an inconsistency in the original set of transactions. In another example, a repair transaction may be a new transaction to replace a transaction in the set of transactions corresponding to the break. For example, a new transaction may include updated transaction information, like an updated amount of an asset or value of an asset, and indicate a prior transaction (e.g., a transaction identifier) included in the set of transactions corresponding to the break that is to be replaced (e.g., with the new, corrective transaction) to enforce consistency between the records 231A, 231B.

The RAS 143, as described above, may receive an exception message 233 from a reconciliation application 141, such as via a messaging service or API of the RAS. The RAS 143 may determine a unique RAS ID in response to receiving the exception message and return the RAS ID to the reconciliation application 141 that reported the exception. The RAS ID may be used to track processing and results of processing a break described by the exception message. Some examples may generate a RAS ID, such as by cryptographically hashing the exception message or a set of transactions identified as corresponding to the break. Other examples may assign a next identifier, like in a sequence of identifiers.

As shown, the RAS 143 may include one or more modules by which a break may be processed, such as to determine a resolution to the break, like a type of repair to perform that fixes the break. The example embodiment, as shown, includes a classification engine 205, workflow engine 210, resolution engine 215, posting engine 220, and a data store 225, though embodiments need not include every such module or be limited to only those modules. Additionally, functions ascribed to the modules as described below may be distributed among the modules in different ways. A computer system (or systems) implementing the RAS 143 may implement functionality associated with the modules in different ways, such as via API calls between different modules, messaging between the modules, or execution of functionality over a batch of data before those results are conveyed to another module. In some examples, different modules may be implemented by different servers of a server system or systems, such as some modules being executed by computer servers and other modules being executed by storage systems, and other systems handing the calling of execution of different modules upon data stored within storage systems.

In some embodiments, the classification engine 205 may determine a classification of a break. For example, the classification engine 205 may be called to classify a break identified for processing in an exception message. Different classifications of breaks (e.g., type of breaks) may be processed in different ways, and have different types of repairs for resolving respective break types. Some example classifications may include one or more of, but is not limited to, trade breaks, reconciliation breaks, dividend breaks, security position breaks, trade settlement breaks, corporate action breaks, withholding tax breaks, securities lending breaks, short-term investment fund interest breaks, custody fee breaks, loan principal prepayment breaks, loan interest prepayment breaks, and management fee breaks. Classification of a break may be determined based on an identified set of transactions corresponding to the break, the transaction information associated with the transactions in the set, and other data. In some examples, the set of transactions identified as corresponding to the break may be included in an exception message. The exception message may also contain varying degrees of transaction information with respect to those transactions. Accordingly, in some cases, the classification engine 205 may obtain additional data by which that transaction information is enriched to determine a classification, such as where the transaction information lacks relevant data by which a classification is determined.

In some embodiments, the classification engine 205 may then obtain other data by which a classification is determined from one or more internal and/or external data sources (which may be, for example, third-party data sources, etc.). In either case, the classification engine 205 may generate an API request to request relevant data from a source, which in some cases may be based on transaction information of transactions in the set. For example, if the transactions in the set pertain to a security, the classification engine 205 may request security pricing information from one or more sources, which may be current pricing and/or historical pricing. Additionally, the classification engine 205 may request information about amounts of securities held by an entity from one or more internal (e.g., custody and/or accounting side) or external (e.g., accounting where applicable) sources. The classification engine 205 may also request information about accounts, like a hierarchy of accounts, based on one or more accounts indicated within the set of transactions. For example, some breaks may correspond to a discrepancy in transactions involving a deposit or withdrawal (or buying or selling) of an asset from one or more accounts of an entity, and a hierarchy of accounts associated with the entity may be obtained in order to accurately classify the break as occurring on the accounting side (and to which account) or the custody side.

The classification engine 205 may determine a classification based on which side a break occurs on (e.g., custody or accounting). Side information for transactions may be determined based on their source (e.g., source of records a transaction was reported by), like which application or record source the record originated from. In some cases, a field in the transaction information for a transaction may indicate a source of the transaction, which may be reported for each transaction in the set, or the classification engine 205 may determine a value for such a field based on the transaction information or other metadata (e.g., about the exception message, records 231, reporting application or record source, etc.). Some example embodiments may generate one or more API requests to internal or external data sources based on transaction information, like a transaction identifier, to obtain information about the source of the transaction or from the source of the transaction.

The classification engine 205 may determine a classification based on transaction type. Transaction type may be determined based on transaction information, such as whether transaction information indicates the transaction, or transactions, correspond to cash transfers, change (e.g., buy/sell) in amount of a position, stock split, dividend payout or reinvestment, etc. Thus, for example, the classification engine may determine whether there is a discrepancy in an amount of a security position that may be indicative of a position break, a discrepancy in security trade price that may be indicative of a trade break, a discrepancy in amount of withdrawal or deposit of cash that may be indicative of a cash break, a discrepancy in an amount of a dividend that may be indicative of a dividend break, etc. Determinations made by the classification engine 205 may further be based on pricing/amounts/quantities, e.g., a numerical quantity, associated with transactions, source, timestamp corresponding to what date or time the transaction occurred or assets were valued, etc., as described above.

The classification engine 205 may output a classification for a break, like one of the aforementioned break types, and further indicate enriching information about why the break falls under that classification. For example, the classification may indicate that a break is a position break on the accounting side (e.g., based on an accounting side record source failing to report a transaction that is reported on the custody side or otherwise having a discrepancy relative to the custody side transactions). The classification, in some examples, may further indicate an amount of position difference such as for a security, whether the discrepancy is positive or negative (e.g., whether the accounting side should show a smaller or larger amount of the position based on amounts of the position reported in transactions on the custody side), a monetary value associated with the break, such as based on a current price of the security and amount of security, and other factors.

The classification engine 205 may access one or more rules, such as rules 230 maintained in a data store 225 by which breaks are classified. For example, a hierarchy of rules, which may be organized in a nodal structure, like a tree, with parent nodes corresponding to decision points and leaf nodes corresponding to a given classification may be utilized to classify a break. Rules and their values, such as for applying a threshold or making a determination based on transaction information or other information associated with the break may cause a selection of a next node to traverse through the hierarchy and execute next may be stored in the data store 225. Some nodes may include logic for obtaining internal or external from a data source, such as via an API request, to which one or more rules of that node or a next node are applied. The classification engine 205 may access rules data 230 stored within the data store 225 to obtain one or more rules, values, and how to apply them (e.g., like a tree data structure or next node in such a structure implementing similar functionality, like a linked list of nodes) to classify a break.

In some embodiments, the classification engine 205 may execute one or more machine learning models 235 maintained in a data store 225 by which a classification is determined, or confirmed, for a break. A training record set may be constructed based on information associated with breaks (e.g., as received in an exception message or obtained from internal or external sources) and their classification to train a machine learning model made accessible to the classification engine. Classifications like those described above may correspond to an output set of a model, and information obtained about a break may correspond to an input set. The model may be iteratively trained to determine an output classification based on the information provided as input. Some examples may apply a tiered approach, such as by implementing a hierarchy or sequence of models, where an initial classification output by a first model executed for a given set of inputs may yield a definitive classification or classification as a member of a set of possible classifications (e.g., an output corresponding to a grouping thereof) where the latter classification may indicate that additional input information is needed (and which may be obtained from an internal or external source) to perform that classification (e.g., by a next model in the sequence, like a pipeline). In turn, the classification engine 205 may obtain additional information, which may be provided as input to the next model (which may be selected based on group classification, or the next model may receive the group classification), and that next model may output a definitive classification (or another group classification as the break cannot yet be definitively classified as a specific member of that group). The above process may be performed until a definitive classification is output. Some examples may train such a pipeline of models with end-to-end training, or train each model individually, or a combination thereof. For example, some models in a hierarchy may be trained individually and some branches of models may be trained with end-to-end training. In some embodiments, the classification engine 205 may determine a classification based on a combination or multiple combinations of one or more rules from the rules 230 and one or more ML models from ML models 235 (explained in further detail herein).

Different classifications may correspond to different workflows to be implemented by the workflow engine 210. For example, a given classification may correspond to a workflow in a set of workflows, e.g., a set of Workflow Process models 240 (such as DMNs, BPMNs, etc.). The correspondence may be 1:1, or some to one (e.g., in some cases two or more breaks may correspond to a same workflow), but in either case, each classification yields to the selection of a given workflow from a set of workflows. Expected use cases may rely on a set of workflows having 5, 10, or 100s of member workflows. For example, a workflow may be specific to a given classification that is relatively detailed (e.g., position break, accounting side or custody side, amount discrepancy, buy or sell side, etc.). In some examples, each classification is mapped to a workflow, such as by a lookup table, by which a classification yields to lookup of a corresponding workflow, e.g., in the set of Workflow Process models 240.

The workflow engine 210 may initialize and orchestrate execution of a workflow selected based on a classification of a break for processing that break. For example, based on the classification determined for a break, the workflow engine 210 may select a workflow from a set of workflows, e.g., in the set of Workflow Process models 240, and perform function calls to execute logic associated with the workflow. The workflow engine 210 may perform one or more API calls to obtain information from internal or external data sources pertinent to resolving a break in accordance with the workflow, like current market pricing of a security. The workflow engine 210 may orchestrate execution of functionality of one or more modules of the RAS 143 in accordance with the workflow. For example, the workflow engine 210 may perform an API call to execute functionality of the resolution engine 215 or the posting engine 220 in accordance with the workflow.

Each workflow in the set of workflows may be associated with rules implementing logic (e.g., like thresholds and decisions) for processing a given classification of break. Rules associated with a workflow may be specified and stored within the data store 225, and then loaded upon selection of the workflow for execution. Some rules may be workflow specific and some rules may be used for two or more workflows. A workflow may define how and when a rule is to be applied when processing a break, and what information is required to successfully execute the workflow.

The workflow engine 210 may be used to generate a workflow for processing a break. For example, a user interface may indicate existing rules and options to specify new rules. The user interface may provide options for defining logic associated with the execution of rules, like API request formats by which information is requested from a data source, or transaction format schemas for different record systems 145. Thus, for example, a user may utilize the interface to construct and order operations by which a given classification of break is processed, upon what data the resolution engine 215 should execute and how the resolution engine is to determine the resolution. Transaction schemas may also be specified, such as with respect to different record systems 145 to which a transaction is sent to be effectuated. For example, the posting engine 220 may generate transactions based on information associated with a determined resolution and schema of the record system 145 to which a transaction is to be sent.

The resolution engine 215 may be called to execute and/or determine a resolution action (e.g., type of repair) for a break in accordance with a workflow based on information associated with the break. For example, the resolution engine 215 may be called to determine actions and values associated with those actions for a type of repair, like adjusting an amount of cash or security to be allocated to (or deallocated from) a given account (or with respect to two or more accounts) that will repair the break in the set of transactions corresponding to the break. Other example repair types may adjust an amount of change in principal of a loan by which an account is to be increase or decreased, or amount of interest incurred for a loan by which an account is to be increased or decreased, or change in amount of interest incurred by which an account is to be increased or decreased. Other example repair types may specify updated transaction information. For example, the resolution engine 215 may determine actions and values like which transaction information for a transaction to update and the updated value to repair a break, such as where prior transaction information contains inaccurate information. Thus, the resolution engine 215 may determine an action that when effected by a repair transaction having the specified associated properties implements a type of repair that resolves a break in the set of transaction. It should be noted that in some embodiments, some or all of the functionality of the resolution engine 215 may be incorporated in and/or executed by other modules within RAS 143. For example, rules in rules 230 and/or calculations in the Workflow Engine 210 may be used to determine the resolution needed for each type of break.

The posting engine 220 may be called to execute and/or generate a transaction to be transmitted 235 to a given record system 145. The posting engine 220 may generate a transaction in accordance with the properties specified for the repair transaction as determined by the resolution engine 215 and a transaction schema compatible with a record system 145 to receive the transaction. The posting engine 220 may format transaction information for a repair transaction in accordance with an input schema of a record system 145 to receive the transaction 235. Thus, for example, the posting engine 220 may receive properties for one or more repair transactions from the resolution engine 215 and record system input schema information for generating one or more repair transactions having transaction information compatible with the schema of that record system 145. Some example repair transactions may specify a new transaction to be effectuated by a record system 145. Some repair transactions may specify a new transaction to replace or update a prior transaction effectuated by the record system 145. In some examples, a repair transaction (or corrective transaction) may be a cancel and replace of a prior transaction. Such transactions generated by the posting engine 220 may include an identifier of a specific prior transaction to strike from a record set, and that identifier may be conveyed in the transaction information for the repair transaction in accordance with the input schema of the record system 145 that generated the record set. Embodiments of the posting engine 220 may include a variety of other pertinent transaction information, like RAS ID, repair type, account information, etc. that is conveyed in association with transactions as reported in records 231.

The RAS 143 may transmit one or more repair transactions 235 to one or more record systems 145 in association with processing a break and obtain acknowledgement responses 236 from the record systems 145 of receipt or effectuation of the repair transactions. In turn, the RAS 143 may update a status of break processing (e.g., as complete) upon receipt of acknowledgment, such as by marking a RAS ID of the break as processed. Thus, for example, status of processing a break by the RAS 143 may be monitored by open and closed RAS IDs within the RAS 143, and subsequent closing of an exception tracked by a reconciliation application 141 based on RAS ID may confirm the repair of the break.

Data store 225 may store data like that described above and used by one or more components within the RAS 143. For example, the data store 225 may maintain sets of rules 230 which may be obtained by one or more components for processing breaks. In some examples, each set of rules may be associated with a given workflow. Rules 230 may be updated for a workflow to modify thresholds or otherwise adjust conditions for transitioning from one step to another of the workflow. In another example, rules 230 may be updated for determining how to classify a break. For example, one or more thresholds, conditions, or external APIs to query for data may be modified or specified to adjust how a break is classified based on an exception message. The data store 225 may also store machine learning models 235 in various stages of training and their associated training data. The data store 225 may also store results determined by one or more of the components within the RAS 143. Some embodiments of the data store 225 may be coupled to a message bus or accessible via an API to store and log messages or requests and responses for data maintained within the data store 225. Data within the data store 225 may be interrogated for centralized governance functions, risk categorization and escalation of breaks, near real-time reporting and analytics, client reporting, and other business critical processes.

As outlined above, embodiments of the RAS 143 provide a standard environment to build and deploy application components and services that automate functions like break classification and determinations of repair type and properties for transaction postings to source applications to resolve breaks. Break processing automation is expected to resolve breaks without manual intervention and more accurately than manual processes. Moreover, the processes implemented by the RAS 143 that led to a given outcome may be provable in audits, along with the reasons why the given outcome was produced. This reduces risk by virtue of assurance that a standard known process is consistently applied to a given break type. Additionally, such standardization of handling and classification of breaks via automation enriches available data points for improved analytics because the information and logic upon which determinations are made are inherently resident to the system and not with human operators. Such data points may then be incorporated into further machine learning and/or rules generation for increasingly accurate and efficient automation.

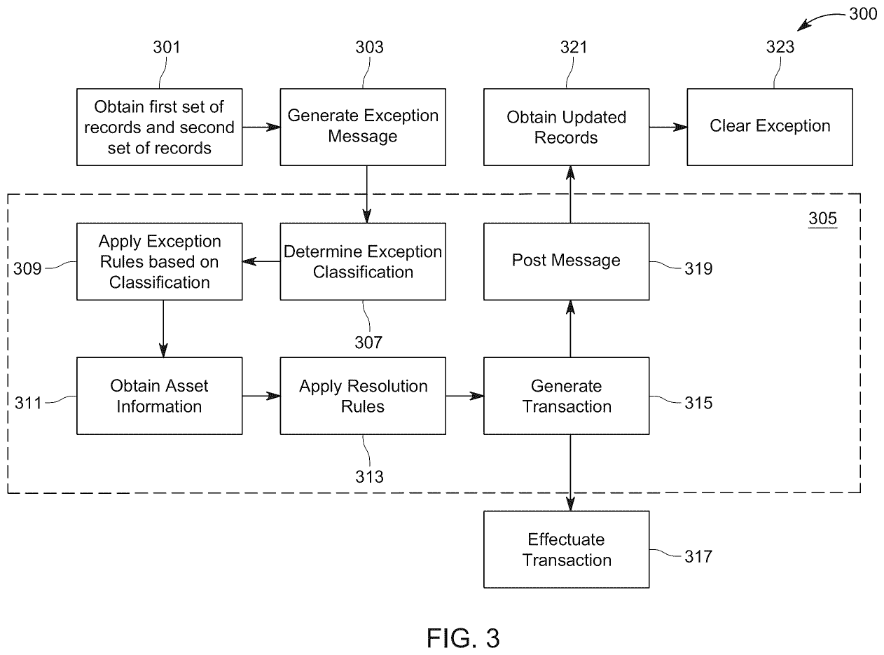

FIG. 3 depicts a flowchart illustrating an embodiment of a method or process 300 for processing a break to determine a resolution for the break. In some embodiments, process 300 may be implemented by one or more algorithms which may be configured to be executed on a computing device, such as a computing device executing one or more applications or processes within the context of an environment 100 like that described with reference to FIG. 1. For example, a reconciliation system 140 may execute one or more steps of process 300 to identify, process, and resolve a break in accordance with the techniques described herein.

Embodiments of process 300 may output one or more corrective transactions determined to resolve a break and information about those transactions. In some examples, embodiments of process 300 may output a corrective transaction by which a trade is to be executed to resolve a break. Additionally, embodiments of the process may post information corresponding to the resolution by which other applications or systems may update records of their transactions. Some embodiments of the example process 300 may include additional or other steps, and some steps may be combined or omitted, such as depending on the use case.

In a step 301, embodiments of a process 300 for processing a break may include obtaining a first set of records and a second set of records corresponding to different record sources. For example, a computing device may obtain a first set of records and a second set of records, such as from or corresponding to different applications, such as a first application distinct from a second application. The different applications need not execute on different computing devices to constitute being different or distinct applications, rather, the terminology is intended to emphasize that the different applications generate respective sets of records that are distinctly attributable to the respective application (e.g., record source). In some embodiments, a computing device executing the process 300 may execute one or more of the other applications, which is not to suggest that the computing device executing the process cannot be distinct from computing devices (or device) executing those applications. In some example embodiments, a first set of records may include records of transactions stored by a first application, such as an accounting application, and a second set of records may include records of transactions stored by a second application, such as a custody application.

In step 301, the first records and second records may be analyzed to determine whether there exists an exception condition between the first records and second records. For example, embodiments may determine whether transaction information included in the records indicates an exception quantity, where an exception quantity reflects an identified difference in relevant values contained in transaction information for a position across one or more transactions identified based on the records and corresponding to the position. For example, an exception quantity may correspond to an identified difference based on inflow and outflow quantities (e.g., transaction information) reported for transactions described by the records.

As described above, a first set of records may be distinctly attributable to a first application or records source, and a second set of records may be distinctly attributed to a second application or records source. In some embodiments, a first set and a second set of transactions may be selected from respective record sets, such as based on transaction information. For example, respective subsets of transactions occurring over a given period of time for analysis may be selected from the records where the records include transactions occurring over a greater period of time. In another example, respective subsets of transactions corresponding to a given asset, like a given security, may be selected from the records where the records include transactions corresponding to multiple assets. In another example, respective subsets of transactions corresponding to a given account or fund may be selected from the records where the records include transactions corresponding to multiple funds or accounts. Embodiments of the process may select respective subsets based on applying one or more of the above criteria to a respective record set as applicable. Thus, for example, a first subset of transactions may be selected (or obtained) from the first set of records and a second subset of transactions may be selected (or obtained) from the second set of records for analysis to determine whether an exception is detected among the selected transactions based on their transaction information.

In cases where inflows and outflows are consistent among transactions reported for the security by the first record set and the second record set, an exception quantity value based on matching of inflows and outflows across transactions of the two records sets will be zero and no exception message need be generated. In other words, an exception may not be detected when each transaction reported in the first set of records and each transaction reported in the second set of records is a member of a pairwise match, such as a distinct pairwise match, with no records remaining unmatched (or orphaned by the matching). If an exception is not detected, the process 300 may obtain next respective subsets of transactions from the record sets based on modified criteria, such as for a next or another asset (like a next or another security identifier indicated in transaction information for at least one transaction in at least one record set), or a different time period, or a different account or fund, to determine whether an exception exists among transactions meeting the modified criteria. In some aspects, the process may iterate over a plurality of pairings of records sets or transaction selection criteria within a given pairing until detecting an exception.

Conversely, in cases where an exception is detected, such as in response to inflows and outflows being inconsistent among transactions reported for the security by the first record set and the second record set, an exception quantity value will exist based on the amount of disagreement between inflows or outflows (or both) reported among the transactions. In other words, an exception may be detected when at least one transaction reported in the first set of records or in the second set of records is not a member of a pairwise match.

In a step 303, embodiments of the process 300 may generate an exception message responsive to detecting an exception among the reported transactions. An exception message may include one or more transactions and a record source or application identifier for each transaction (e.g., whether the transaction corresponds to a first application/source or second application/source). The included transactions may be the subsets of transactions for which the break is detected, such as those meeting the selection criteria applied to the first and second sets of records for matching reported inflows and outflows by which the break is detected.

In some examples, steps 301 and 303 may be executed by a reconciliation application, and the exception message may correspond to a request for processing a break within a reconciliation automation system (RAS) 305, such as in accordance with the techniques described below. Some embodiments of a RAS may implement one or more of processes 301, 303, 317, 321, and 323, and in some other embodiments, one or more steps 309-315 may be implemented by components providing similar functionality outside the context of a RAS.

In a step 307, embodiments of the process 300 may classify an exception, like a break in a set of transactions, such as based on information about the set of transactions which may be obtained from exception message 303. As noted above, the exception message 303 may detail one or more transactions with their corresponding transaction information and record source. Embodiments of step 307 may obtain information about one or more transactions corresponding to the exception. For example, one or more data sources, which may include third-party and/or other external APIs, may be queried to enrich transaction or exception data for classification of the exception.

Classification of an exception, like a break, may be based in part on transaction information of transactions in an identified set of transactions corresponding to the break. For example, embodiments may determine a classification based on whether a value is positive or negative, which record source that value is associated with, and what type of asset the value and transactions corresponds (e.g., like a security, cash, loan, dividend, etc.). In some examples, a value may be determined to be negative or positive based on whether a transaction corresponds to the first record set or the second record set and whether the transaction corresponds to a buying or selling of a security (e.g., whether an amount of change in position corresponds to an increase or decrease), or other discrepancy among the identified records. In other words, the classification may be indicative of whether the break corresponds to a reported shortage or overage of an asset (whether a security or monetary amount) with respect to a record source.

In some embodiments, break classification may be determined based on classification rules applied to transaction information, internal or external source data obtained about the transaction or transaction information, record source, directionality of values (e.g., positive or negative), etc. In some embodiments, break classification may be determined by a machine learning model. The machine learning model may be trained on training records that include at least some records that associate inputs with outputs, such as data corresponding to a break and classification of the break. In yet other embodiments break classification may be determined based on a combination of classification rules and machine learning models.

In a step 309, embodiments of the process 300 may apply exception rules based on the classification determined for the exception. In some examples, exception rules may be implemented in accordance with a workflow selected from a set of workflows responsive to the classification. Embodiments may select a given workflow among a plurality of workflows based on the classification. Workflow rules, in some examples, may contain logic for obtaining asset information 311 to which other rules may be applied or other processes rely on (e.g., information to repair the break). For example, in step 311, one or more internal or external data source APIs may be queried to obtain data for performing a type of repair based on the classification.

In a step 311, embodiments of the process 300 may obtain classification relevant information about assets like a security position, account, source, loan amount, etc. corresponding to the break. In examples corresponding to a break in transactions associated with a security, one or more data sources, which may include external (e.g., third-party) APIs, may be queried to determine costs associated with the break. Examples of such data may include, but are not limited to, a market or trade price of a security corresponding to a transaction. Market or trade pricing may be obtained based on a timestamp associated with a transaction, pricing at market close based on date, current market or trade pricing, or combination thereof.

In a step 313, embodiments of the process 300 may apply one or more resolution rules for a type of repair, such as in accordance with the selected workflow and based on the obtained asset information and classification. A repair of a given type may be implemented by taking one or more actions having properties that correct a break in a set of transaction.

In one example, a break classification may indicate a break with respect to a given record source and whether that break is associated with a positive or negative value with respect to the record source. For such an example exception, like a position break, a repair type and properties may be based on an exception quantity detected or identified from a comparison of inflow quantity values reported for transactions within the first record set to inflow quantity values reported for transactions within the second record set, and a likewise comparison for outflow quantity values. The exception quantity may be determined when a net quantity value based on a sum of conditionally formatted quantities (e.g., based on buy/sell for respective record source) is non-zero, that result being indicative of a transaction break between transactions from the first record set and transactions from the second record set. Embodiments of the process may conditionally format a value within one or more of the aforementioned fields or data categories, such as either negative or positive, based on whether a transaction corresponds to the first record set or the second record set and whether the transaction corresponds to a buying or selling of the security (e.g., whether an amount of change in position corresponds to an increase or decrease). In some examples, whether a value within a field is positive or negative may be determined based on conditionally formatted value, like an amount of position change associated with the transaction (e.g., a signed quantity value determined in associated with step 302), and an unsigned (e.g., positive value) from another field. An action for the repair type (e.g., correcting a different in reported amounts of positions) may be to update records to indicate a buy, or sell, of a position, or to perform a buy or sell of a position, and properties of the action may correspond to amounts and values corresponding to those actions.

In another example, a break may be indicative of a given record source, like an accounting application, missing one or more transactions corresponding to a sale of a security. The resolution rules may determine that the record source should be credited for the sale of the security, and a monetary value to be credited may be based on an exception amount corresponding to the security and market value or trade value of the security corresponding to a timestamp associated with the transaction (which in some example, may be those obtained from a transaction identified in the other set of records, such as those corresponding to a custody application). In turn, embodiments may generate a corrective transaction 315, such as a transaction that is posted to effectuate 317 a transfer of the determined monetary value to the accounting application (e.g., to an account associated with the record source).

In another example, such as for a break indicative of a missing transaction corresponding to a sale on a custody side, the resolution rules may determine how to handle a determined monetary value corresponding to a difference between current security pricing and prior security pricing at the time of the discrepancy for a missing transaction. Here, embodiments may determine to generate a transaction 315 corresponding to a trade of the security, whether at a loss or gain, and a corresponding write off if at a loss, or generate a corrective transaction 315 corresponding to an account holding a monetary value equivalent or greater than the amount of the sale that should be decremented by the amount credited to the accounting side. In the case of a corrective transaction for trading a security, a transaction may be generated 315 for executing during a next trading period, which may be effectuated 317 on a securities market. In the case of a corrective transaction not involving a trade, one or more transactions may be generated 315 and posted to effectuate the resolution (e.g., write offs, decrementing an account, etc.).

In step 315, one or more transactions 315 may be generated in accordance with the determined actions and properties for repairing a break as determined by application of the resolution rules. Some examples of which are described above. Each generated transaction may be associated with a RAS ID, such as based on the RAS ID corresponding to the break which the transaction is determined to resolve (whether in full, or in part). Accordingly, when a corrected transaction is effectuated at step 317 based on the associated transaction information, or otherwise included in an updated set of records 321 such as responsive to the posting 319 of the transaction (e.g., to a message bus) for updating a given record source, the generated transaction may be identified with respect to the break. For example, updated sets of records 321 may be obtained from record sources for which the break was identified in association with a next record review cycle (e.g., the next hour, minute, day, month, statement, quarter, etc.), and the updated sets of records may be examined for transactions associated with a RAS ID corresponding to an open break (e.g., a RAS ID returned in response to an exception message). The transactions (in the updated records, e.g., new transactions) associated with the RAS ID corresponding to the open exception for the break may be selected for analysis in connection with (e.g., prior) transactions corresponding to the original detected exception, such as to determine whether the updated records including those corrective transactions resolve the break and the open exception may be cleared at step 323. The RAS ID may also serve to flag those transactions within the updated records that should be omitted from comparisons between the updated records as they serve to resolve open exceptions arising from breaks in records from a prior analysis cycle.

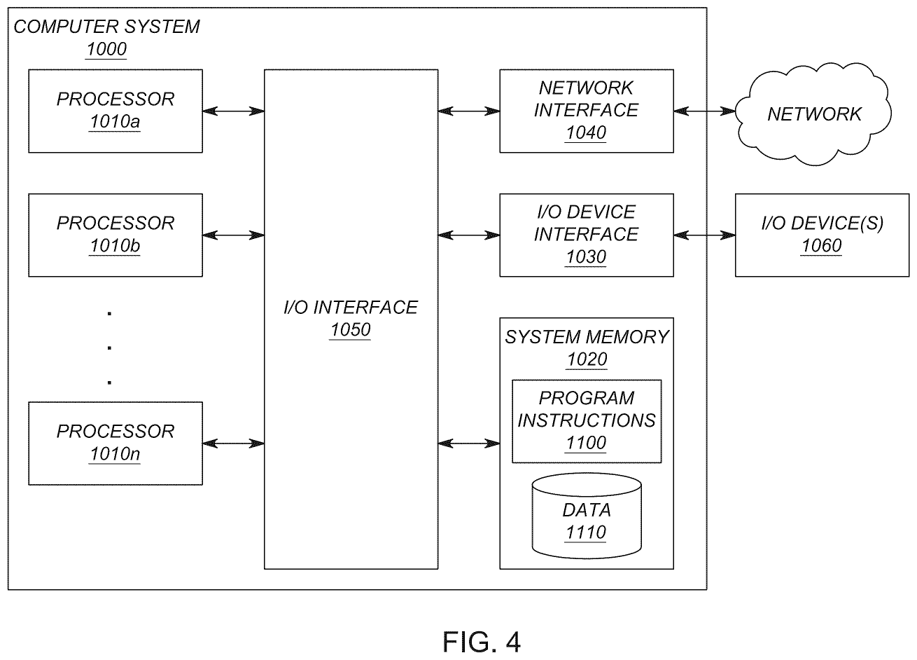

Some embodiments may execute the above operations on a computer system, such as the computer system of FIG. 4, which is a diagram that illustrates a computing system 1000 in accordance with embodiments of the present techniques. Various portions of systems and methods described herein, may include or be executed on one or more computer systems similar to computing system 1000. Further, processes and modules described herein may be executed by one or more processing systems similar to that of computing system 1000.

Computing system 1000 may include one or more processors (e.g., processors 1010a-1010n) coupled to system memory 1020, an input/output I/O device interface 1030, and a network interface 1040 via an input/output (I/O) interface 1050. A processor may include a single processor or a plurality of processors (e.g., distributed processors). A processor may be any suitable processor capable of executing or otherwise performing instructions. A processor may include a central processing unit (CPU) that carries out program instructions to perform the arithmetical, logical, and input/output operations of computing system 1000. A processor may execute code (e.g., processor firmware, a protocol stack, a database management system, an operating system, or a combination thereof) that creates an execution environment for program instructions. A processor may include a programmable processor. A processor may include general or special purpose microprocessors. A processor may receive instructions and data from a memory (e.g., system memory 1020). Computing system 1000 may be a uni-processor system including one processor (e.g., processor 1010a), or a multi-processor system including any number of suitable processors (e.g., 1010a-1010n). Multiple processors may be employed to provide for parallel or sequential execution of one or more portions of the techniques described herein. Processes, such as logic flows, described herein may be performed by one or more programmable processors executing one or more computer programs to perform functions by operating on input data and generating corresponding output. Processes described herein may be performed by, and apparatus can also be implemented as, special purpose logic circuitry, e.g., an FPGA (field programmable gate array) or an ASIC (application specific integrated circuit). Computing system 1000 may include a plurality of computing devices (e.g., distributed computer systems) to implement various processing functions.

I/O device interface 1030 may provide an interface for connection of one or more I/O devices 1060 to computer system 1000. I/O devices may include devices that receive input (e.g., from a user) or output information (e.g., to a user). I/O devices 1060 may include, for example, graphical user interface presented on displays (e.g., a cathode ray tube (CRT) or liquid crystal display (LCD) monitor), pointing devices (e.g., a computer mouse or trackball), keyboards, keypads, touchpads, scanning devices, voice recognition devices, gesture recognition devices, printers, audio speakers, microphones, cameras, or the like. I/O devices 1060 may be connected to computer system 1000 through a wired or wireless connection. I/O devices 1060 may be connected to computer system 1000 from a remote location. I/O devices 1060 located on remote computer system, for example, may be connected to computer system 1000 via a network and network interface 1040.

Network interface 1040 may include a network adapter that provides for connection of computer system 1000 to a network. Network interface 1040 may facilitate data exchange between computer system 1000 and other devices connected to the network. Network interface 1040 may support wired or wireless communication. The network may include an electronic communication network, such as the Internet, a local area network (LAN), a wide area network (WAN), a cellular communications network, or the like.

System memory 1020 may be configured to store program instructions 1100 or data 1110. Program instructions 1100 may be executable by a processor (e.g., one or more of processors 1010a-1010n) to implement one or more embodiments of the present techniques. Instructions 1100 may include modules of computer program instructions for implementing one or more techniques described herein with regard to various processing modules. Program instructions may include a computer program (which in certain forms is known as a program, software, software application, script, or code). A computer program may be written in a programming language, including compiled or interpreted languages, or declarative or procedural languages. A computer program may include a unit suitable for use in a computing environment, including as a stand-alone program, a module, a component, or a subroutine. A computer program may or may not correspond to a file in a file system. A program may be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program may be deployed to be executed on one or more computer processors located locally at one site or distributed across multiple remote sites and interconnected by a communication network.

System memory 1020 may include a tangible program carrier having program instructions stored thereon. A tangible program carrier may include a non-transitory computer readable storage medium. A non-transitory computer readable storage medium may include a machine-readable storage device, a machine-readable storage substrate, a memory device, or any combination thereof. Non-transitory computer readable storage medium may include non-volatile memory (e.g., flash memory, ROM, PROM, EPROM, EEPROM memory), volatile memory (e.g., random access memory (RAM), static random access memory (SRAM), synchronous dynamic RAM (SDRAM)), bulk storage memory (e.g., CD-ROM and/or DVD-ROM, hard-drives), or the like. System memory 1020 may include a non-transitory computer readable storage medium that may have program instructions stored thereon that are executable by a computer processor (e.g., one or more of processors 1010a-1010n) to cause the subject matter and the functional operations described herein. A memory (e.g., system memory 1020) may include a single memory device and/or a plurality of memory devices (e.g., distributed memory devices). Instructions or other program code to provide the functionality described herein may be stored on a tangible, non-transitory computer readable media. In some cases, the entire set of instructions may be stored concurrently on the media, or in some cases, different parts of the instructions may be stored on the same media at different times.

I/O interface 1050 may be configured to coordinate I/O traffic between processors 1010a-1010n, system memory 1020, network interface 1040, I/O devices 1060, and/or other peripheral devices. I/O interface 1050 may perform protocol, timing, or other data transformations to convert data signals from one component (e.g., system memory 1020) into a format suitable for use by another component (e.g., processors 1010a-1010n). I/O interface 1050 may include support for devices attached through various types of peripheral buses, such as a variant of the Peripheral Component Interconnect (PCI) bus standard or the Universal Serial Bus (USB) standard.

Embodiments of the techniques described herein may be implemented using a single instance of computer system 1000 or multiple computer systems 1000 configured to host different portions or instances of embodiments. Multiple computer systems 1000 may provide for parallel or sequential processing/execution of one or more portions of the techniques described herein.

Those skilled in the art will appreciate that computer system 1000 is merely illustrative and is not intended to limit the scope of the techniques described herein. Computer system 1000 may include any combination of devices or software that may perform or otherwise provide for the performance of the techniques described herein. For example, computer system 1000 may include or be a combination of a cloud-computing system, a data center, a server rack, a server, a virtual server, a desktop computer, a laptop computer, a tablet computer, a server device, a client device, a mobile telephone, a personal digital assistant (PDA), a mobile audio or video player, a game console, a vehicle-mounted computer, or a Global Positioning System (GPS), or the like. Computer system 1000 may also be connected to other devices that are not illustrated, or may operate as a stand-alone system. In addition, the functionality provided by the illustrated components may in some embodiments be combined in fewer components or distributed in additional components. Similarly, in some embodiments, the functionality of some of the illustrated components may not be provided or other additional functionality may be available.

Those skilled in the art will also appreciate that while various items are illustrated as being stored in memory or on storage while being used, these items or portions of them may be transferred between memory and other storage devices for purposes of memory management and data integrity. Alternatively, in other embodiments some or all of the software components may execute in memory on another device and communicate with the illustrated computer system via inter-computer communication. Some or all of the system components or data structures may also be stored (e.g., as instructions or structured data) on a computer-accessible medium or a portable article to be read by an appropriate drive, various examples of which are described above. In some embodiments, instructions stored on a computer-accessible medium separate from computer system 1000 may be transmitted to computer system 1000 via transmission media or signals such as electrical, electromagnetic, or digital signals, conveyed via a communication medium such as a network or a wireless link. Various embodiments may further include receiving, sending, or storing instructions or data implemented in accordance with the foregoing description upon a computer-accessible medium. Accordingly, the present techniques may be practiced with other computer system configurations.

In block diagrams, illustrated components are depicted as discrete functional blocks, but embodiments are not limited to systems in which the functionality described herein is organized as illustrated. The functionality provided by each of the components may be provided by software or hardware modules that are differently organized than is presently depicted, for example such software or hardware may be intermingled, conjoined, replicated, broken up, distributed (e.g. within a data center or geographically), or otherwise differently organized. The functionality described herein may be provided by one or more processors of one or more computers executing code stored on a tangible, non-transitory, machine readable medium. In some cases, notwithstanding use of the singular term “medium,” the instructions may be distributed on different storage devices associated with different computing devices, for instance, with each computing device having a different subset of the instructions, an implementation consistent with usage of the singular term “medium” herein. In some cases, external (e.g., third party) content delivery networks may host some or all of the information conveyed over networks, in which case, to the extent information (e.g., content) is said to be supplied or otherwise provided, the information may provided by sending instructions to retrieve that information from a content delivery network.

The reader should appreciate that the present application describes several independently useful techniques. Rather than separating those techniques into multiple isolated patent applications, applicants have grouped these techniques into a single document because their related subject matter lends itself to economies in the application process. But the distinct advantages and aspects of such techniques should not be conflated. In some cases, embodiments address all of the deficiencies noted herein, but it should be understood that the techniques are independently useful, and some embodiments address only a subset of such problems or offer other, unmentioned benefits that will be apparent to those of skill in the art reviewing the present disclosure. Due to costs constraints, some techniques disclosed herein may not be presently claimed and may be claimed in later filings, such as continuation applications or by amending the present claims. Similarly, due to space constraints, neither the Abstract nor the Summary sections of the present document should be taken as containing a comprehensive listing of all such techniques or all aspects of such techniques.

It should be understood that the description and the drawings are not intended to limit the present techniques to the particular form disclosed, but to the contrary, the intention is to cover all modifications, equivalents, and alternatives falling within the spirit and scope of the present techniques as defined by the appended claims. Further modifications and alternative embodiments of various aspects of the techniques will be apparent to those skilled in the art in view of this description. Accordingly, this description and the drawings are to be construed as illustrative only and are for the purpose of teaching those skilled in the art the general manner of carrying out the present techniques. It is to be understood that the forms of the present techniques shown and described herein are to be taken as examples of embodiments. Elements and materials may be substituted for those illustrated and described herein, parts and processes may be reversed or omitted, and certain features of the present techniques may be utilized independently, all as would be apparent to one skilled in the art after having the benefit of this description of the present techniques. Changes may be made in the elements described herein without departing from the spirit and scope of the present techniques as described in the following claims. Headings used herein are for organizational purposes only and are not meant to be used to limit the scope of the description.

As used throughout this application, the word “may” is used in a permissive sense (i.e., meaning having the potential to), rather than the mandatory sense (i.e., meaning must). The words “include”, “including”, and “includes” and the like mean including, but not limited to. As used throughout this application, the singular forms “a,” “an,” and “the” include plural referents unless the content explicitly indicates otherwise. Thus, for example, reference to “an element” or “a element” includes a combination of two or more elements, notwithstanding use of other terms and phrases for one or more elements, such as “one or more.” The term “or” is, unless indicated otherwise, non-exclusive, i.e., encompassing both “and” and “or.” Terms describing conditional relationships, e.g., “in response to X, Y,” “upon X, Y,”, “if X, Y,” “when X, Y,” and the like, encompass causal relationships in which the antecedent is a necessary causal condition, the antecedent is a sufficient causal condition, or the antecedent is a contributory causal condition of the consequent, e.g., “state X occurs upon condition Y obtaining” is generic to “X occurs solely upon Y” and “X occurs upon Y and Z.” Such conditional relationships are not limited to consequences that instantly follow the antecedent obtaining, as some consequences may be delayed, and in conditional statements, antecedents are connected to their consequents, e.g., the antecedent is relevant to the likelihood of the consequent occurring. Statements in which a plurality of attributes or functions are mapped to a plurality of objects (e.g., one or more processors performing steps A, B, C, and D) encompasses both all such attributes or functions being mapped to all such objects and subsets of the attributes or functions being mapped to subsets of the attributes or functions (e.g., both all processors each performing steps A-D, and a case in which processor 1 performs step A, processor 2 performs step B and part of step C, and processor 3 performs part of step C and step D), unless otherwise indicated. Similarly, reference to “a computer system” performing step A and “the computer system” performing step B can include the same computing device within the computer system performing both steps or different computing devices within the computer system performing steps A and B. Further, unless otherwise indicated, statements that one value or action is “based on” another condition or value encompass both instances in which the condition or value is the sole factor and instances in which the condition or value is one factor among a plurality of factors. Unless otherwise indicated, statements that “each” instance of some collection have some property should not be read to exclude cases where some otherwise identical or similar members of a larger collection do not have the property, i.e., each does not necessarily mean each and every. Limitations as to sequence of recited steps should not be read into the claims unless explicitly specified, e.g., with explicit language like “after performing X, performing Y,” in contrast to statements that might be improperly argued to imply sequence limitations, like “performing X on items, performing Y on the X′ed items,” used for purposes of making claims more readable rather than specifying sequence. Statements referring to “at least Z of A, B, and C,” and the like (e.g., “at least Z of A, B, or C”), refer to at least Z of the listed categories (A, B, and C) and do not require at least Z units in each category. Unless specifically stated otherwise, as apparent from the discussion, it is appreciated that throughout this specification discussions utilizing terms such as “processing,” “computing.” “calculating.” “determining” or the like refer to actions or processes of a specific apparatus, such as a special purpose computer or a similar special purpose electronic processing/computing device. Features described with reference to geometric constructs, like “parallel,” “perpendicular/orthogonal,” “square”, “cylindrical,” and the like, should be construed as encompassing items that substantially embody the properties of the geometric construct, e.g., reference to “parallel” surfaces encompasses substantially parallel surfaces. The permitted range of deviation from Platonic ideals of these geometric constructs is to be determined with reference to ranges in the specification, and where such ranges are not stated, with reference to industry norms in the field of use, and where such ranges are not defined, with reference to industry norms in the field of manufacturing of the designated feature, and where such ranges are not defined, features substantially embodying a geometric construct should be construed to include those features within 15% of the defining attributes of that geometric construct. The terms “first”, “second”, “third.” “given” and so on, if used in the claims, are used to distinguish or otherwise identify, and not to show a sequential or numerical limitation. As is the case in ordinary usage in the field, data structures and formats described with reference to uses salient to a human need not be presented in a human-intelligible format to constitute the described data structure or format, e.g., text need not be rendered or even encoded in Unicode or ASCII to constitute text; images, maps, and data-visualizations need not be displayed or decoded to constitute images, maps, and data-visualizations, respectively; speech, music, and other audio need not be emitted through a speaker or decoded to constitute speech, music, or other audio, respectively. Computer implemented instructions, commands, and the like are not limited to executable code and can be implemented in the form of data that causes functionality to be invoked, e.g., in the form of arguments of a function or API call. To the extent bespoke noun phrases are used in the claims and lack a self-evident construction, the definition of such phrases may be recited in the claim itself, in which case, the use of such bespoke noun phrases should not be taken as invitation to impart additional limitations by looking to the specification or extrinsic evidence.

In this patent, to the extent any U.S. patents, U.S. patent applications, or other materials (e.g., articles) have been incorporated by reference, the text of such materials is only incorporated by reference to the extent that no conflict exists between such material and the statements and drawings set forth herein. In the event of such conflict, the text of the present document governs, and terms in this document should not be given a narrower reading in virtue of the way in which those terms are used in other materials incorporated by reference.

What is claimed is:

1. A method for identifying, evaluating, and repairing a break, comprising:
receiving an indication of a break that has occurred in a transaction system;
identifying a set of transactions associated with the break;
obtaining internal data pertaining to the break;
receiving external data pertaining to the break from one or more external systems;
classifying the break based on the set of transactions, the internal data, and the external data;
determining a type of repair to perform based at least in part on the classification of the break; and
initiating a break resolution based on the determined type of repair.

2. The method as in claim 1, wherein the break is one of:
a trade break,
a reconciliation break,
a dividend break,
a security position break,
a trade settlement break,
a corporate action break,
a withholding tax break,
a securities lending break,
a short-term investment fund interest break,
a custody fee break,
a loan principal prepayment break,
a loan interest prepayment break, or
a management fee break.

3. The method as in claim 1, wherein:
the internal data pertaining to the break comprises metadata associated with the identified set of transactions.

4. The method as in claim 1, wherein:
the external data is received from the one or more external systems via respective external application programming interfaces (APIs).

5. The method as in claim 1, wherein:
the data received from the one or more external systems is used to confirm the accuracy of the internal data pertaining to the break.

6. The method as in claim 1, wherein classifying the break comprises:
applying at least one of one or more rules, or one or more machine learning (ML) models, to the internal data and the received external data.

7. The method as in claim 6, wherein classifying the break further comprises:
identifying a characteristic of the break based on the application of the at least one of the one or more rules or the one or more ML models to the internal data and the received external data.

8. The method as in claim 1, wherein determining the type of repair to perform based at least in part on the classification of the break further comprises:
determining a specific workflow path of a predefined set of workflow paths based at least in part on the classification.

9. The method as in claim 8, wherein initiating the break resolution based on the determined type of repair further comprises:
dispatching the specific workflow path to repair the break.

10. The method as in claim 8, wherein initiating the break resolution based on the determined type of repair further comprises:
determining properties of one or more actions selected to perform the repair based on the specific workflow path; and
constructing one or more repair transactions to effectuate the repair based on the one or more actions and their determined properties.

11. The method as in claim 10, wherein constructing one or more repair transactions to effectuate the repair based on the one or more actions and their determined properties comprises:
selecting one or more of predefined mappings or transformations based on a record system to which a given one of the repair transactions is to be posted to effectuate the repair; and
applying, for at least one of the determined actions and its properties, the one or more predefined mappings or transformations to generate repair transaction information for the repair transaction in a schema of the record system.

12. The method as in claim 1, further comprising:
upon completion of the break resolution, updating a break status of the break.

13. The method as in claim 1, further comprising:
determining an identifier corresponding to the break;
transmitting the identifier corresponding to the break to a reconciliation utility from which the indication of the break is received for association with the break; and
transmitting one or more repair transactions for initiating the break resolution to at least one record system, the one or more repair transactions having transaction information including the identifier corresponding to the break.

14. The method as in claim 13, wherein the reconciliation utility:
receives updated records of transactions including new transactions including the one or more repair transactions;
identifies repair transactions from other new transactions in the records of transactions based on inclusion of a break identifier in their transaction information;
matches the one or more repair transactions to the break based on the identifier; and
determines whether the one or more repair transactions, in combination with the set of transactions corresponding to the break, resolve the break.

15. A system for identifying, evaluating, and repairing a break, comprising:
a computer having a processor and a memory; and
one or more code sets stored in the memory and executed by the processor, which, when executed, configure the processor to:
receive an indication of a break that has occurred in a transaction system;
identify a set of transactions associated with the break;
obtain internal data pertaining to the break;
receive external data pertaining to the break from one or more external systems;
classify the break based on the set of transactions, the internal data, and the external data;
determine a type of repair to perform based at least in part on the classification of the break; and
initiate a break resolution based on the determined type of repair.

16. The system as in claim 15, wherein the break is one of:
a trade break,
a reconciliation break,
a dividend break,
a security position break,
a trade settlement break,
a corporate action break,
a withholding tax break,
a securities lending break,
a short-term investment fund interest break,
a custody fee break,
a loan principal prepayment break,
a loan interest prepayment break, or
a management fee break.

17. The system as in claim 15, wherein:
the internal data pertaining to the break comprises metadata associated with the identified set of transactions.

18. The system as in claim 15, wherein:
the external data is received from the one or more external systems via respective external application programming interfaces (APIs).

19. The system as in claim 15, wherein:
the data received from the one or more external systems is used to confirm the accuracy of the internal data pertaining to the break.

20. The system as in claim 15, wherein, when classifying the break, the processor is configured to:
apply at least one of one or more rules, or one or more machine learning (ML) models to the internal data and the received external data.

21. The system as in claim 20, wherein, when classifying the break, the processor is further configured to:
identify a characteristic of the break based on the application of the at least one of the one or more rules or the one or more ML models to the internal data and the received external data.

22. The system as in claim 15, wherein, when determining the type of repair to perform based at least in part on the classification of the break, the processor is further configured to:
determine a specific workflow path of a predefined set of workflow paths based at least in part on the classification.

23. The system as in claim 22, wherein, when initiating the break resolution based on the determined type of repair, the processor is further configured to:
dispatch the specific workflow path to repair the break.

24. The system as in claim 22, wherein, when initiating the break resolution based on the determined type of repair, the processor is further configured to:
determine properties of one or more actions selected to perform the repair based on the specific workflow path; and
construct one or more repair transactions to effectuate the repair based on the one or more actions and their determined properties.

25. The system as in claim 24, wherein constructing one or more repair transactions to effectuate the repair based on the one or more actions and their determined properties comprises:
selecting one or more of predefined mappings or transformations based on a record system to which a given one of the repair transactions is to be posted to effectuate the repair; and
applying, for at least one of the determined actions and its properties, the one or more predefined mappings or transformations to generate repair transaction information for the repair transaction in a schema of the record system.

26. The system as in claim 15, wherein:
upon completion of the break resolution, the processor is further configured to update a break status of the break.

27. The system as in claim 15, wherein the processor is further configured to:
determine an identifier corresponding to the break;
transmit the identifier corresponding to the break to a reconciliation utility from which the indication of the break is received for association with the break; and
transmit one or more repair transactions for initiating the break resolution to at least one record system, the one or more repair transactions having transaction information including the identifier corresponding to the break.

28. The system as in claim 27, wherein the reconciliation utility:
receives updated records of transactions including new transactions including the one or more repair transactions;
identifies repair transactions from other new transactions in the records of transactions based on inclusion of a break identifier in their transaction information;
matches the one or more repair transactions to the break based on the identifier; and
determines whether the one or more repair transactions, in combination with the set of transactions corresponding to the break, resolve the break.
